(19) United States
(12) Patent Application Publication
(10) Pub. No.: US 2025/0355831 A1
(43) Pub. Date: Nov. 20, 2025

(54) RANDOM DIRECT MEMORY ACCESS NETWORK INTERFACE CONTROLLER

(71) Applicant: Huawei Cloud Computing Technologies Co., Ltd., Gui'an New District (CN)

(72) Inventors: Yigal Korman, Munich (DE); Amit Golander, Munich (DE); Victor Gissin, Munich (DE)

(73) Assignee: Huawei Cloud Computing Technologies Co., Ltd., Gui'an New District (CN)

(21) Appl. No.: 19/281,148

(22) Filed: Jul. 25, 2025

Related U.S. Application Data
(63) Continuation of application No. PCT/EP2023/051880, filed on Jan. 26, 2023.

(51) Int. Cl. G06F 15/173; G06F 13/28

(52) U.S. Cl. CPC G06F 15/17331; G06F 13/28

(57) ABSTRACT

In order to control a Random Direct Memory Access, RDMA to atomic data sectors defined is a sector atomic memory region (102) including atomic sectors (106A-N) of a predefined size to which a RDMA Network Interface Controller, RNIC (100, 202), provides access only to RDMA requests for atomic sectors that are sector size aligned and span one or more of the sectors. An array of counters is created to include a several bit counter for each atomic sector in the sector atomic memory region. Each counter has a bit 0 configured as a write lock bit and further bits configured as read counter bits to be indicative of ongoing operations with the associated atomic sector. The RNIC then handles RDMA requests for an atomic sector from a client using a counter of the atomic sector.

### CROSS-REFERENCE TO RELATED APPLICATIONS

This application is a continuation of International Application No. PCT/EP2023/051880, filed on Jan. 26, 2023, the disclosure of which is hereby incorporated by reference in its entirety.

### TECHNICAL FIELD

The disclosure relates generally to a cloud storage, persistent memory, Random Direct Memory Access (RDMA) networking, distributed systems, and more particularly, the disclosure relates to a method of controlling Random Direct Memory Access (RDMA) to atomic data sectors, and a Random Direct Memory Access (RDMA), Network Interface Controller (RNIC).

### BACKGROUND

Persistent Memory (PM), and Random Direct Memory Access (RDMA) networking are widely used in enterprise and cloud-distributed storages to provide high performance access. The PM is a memory technology that provides store or load access like regular memory without loss of power loss, but the data is persistent. Performance characteristics of the PM may depend on implementation with near order of magnitude to volatile memory. The RDMA provides one-sided operations including read or write to allow access to remote memory without involving a central processing unit (CPU), on a responder side i.e. a client. Further, access control is managed by Memory Regions (MRs), that can be registered to the RDMA network card, RNIC, and invalidated when the access is no longer allowed. Accessing to invalidate MR may trigger a critical network error and close the RDMA connection between the client and a server.

Storage solutions provide a sector atomicity feature that provides a read or write request to a sector on a storage device to execute atomically. The read or write request to the sector may usually be between 512 bytes to 4096 bytes. If the read and write requests are executed in parallel, the storage solution does not provide partial old data and partial new data. For example, a sector includes values AB. Process P1 is reading the sector, and process P2 is writing values CD to the sector in parallel. The P1 read result may be either AB or CD and not CB or AD. This feature is important for providing simplicity of software implementation and most of the existing software includes the feature.

The PM and the RDMA do not include the sector atomicity feature inherently but provide most words with 8 bytes or cache-line with 64 bytes atomicity. Further, high-speed distributed storage systems based on the PM and the RDMA should implement the sector atomicity feature as part of a proprietary storage protocol.

Currently, there are two strategies to implement read access in the high-speed distributed storage systems based on the PM and the RDMA. One of the strategies includes Gate access to sectors on data nodes on a storage side and coordinate read and write access. Each read and write may not be done directly using the RDMA to the remote PM media, but includes a server software stack that coordinates between reads and writes to the same sector to provide atomicity. Another strategy includes structuring the storage data as a journal instead of writing data in-place, which requires maintaining of metadata information about a location of new data. A client read may involve a check of the sector location in the metadata to read the location.

But the two strategies may impact performance and complexity of the solution. Instead of doing direct RDMA read from the PM to access data, the client may send a request to a server software, which involves Operation System, OS, and Central Processing Unit, CPU handling on a server-side resulting in heavily impacting performance. Read request may take ˜4 usec and requires multiple round trips over networks. Reading the metadata is another round trip of the network and includes worse latency than a direct in-place read. Write amplification determining how much needs to be written to represent the sector of user data, in a journal model may be considered high and impacts RIO for an expensive PM media.

Therefore, there arises a need to address the aforementioned technical problem/drawbacks in RDMA protocol and network card to implement sector atomicity for providing read and write operations.

### SUMMARY

Embodiments of the disclosure to provide a method of controlling Random Direct Memory Access. RDMA, to atomic data sectors, and a Random Direct Memory Access (RDMA), Network Interface Controller (RNIC), while avoiding one or more disadvantages of prior art approaches.

The embodiments are achieved by the features of the independent claims. Further, implementation forms are apparent from the dependent claims, the description, and the figures.

The disclosure provides a method of controlling Random Direct Memory Access (RDMA), to atomic data sectors, and a Random Direct Memory Access (RDMA), Network Interface Controller (RNIC).

According to a first aspect, there is provided a method of controlling Random Direct Memory Access (RDMA), to atomic data sectors. The method includes defining a sector atomic memory region including one or more atomic sectors of a predefined size to which a RDMA Network Interface Controller (RNIC), provides access only to RDMA requests for atomic sectors that are sector size aligned and span one or more of the sectors. The method includes creating an array of counters including a several bit counter for each atomic sector in the sector atomic memory region. Each counter has a bit 0 configured as a write lock bit and one or more further bits configured as read counter bits to be indicative of ongoing operations with the associated atomic sector. The method includes in reply to receiving an RDMA read request for an atomic sector from a client, the RNIC handling the RDMA read request using a counter of the atomic sector. The method includes in reply to receiving an RDMA write request for an atomic sector from a client, the RNIC issuing an atomic compare and swap operation to modify a value of a counter of the atomic sector from 0 to 1 and handling the RDMA write request based on a result of the atomic compare and swap operation.

This method provides an optimal solution for providing direct remote access to the sector atomic memory region without requiring multiple round-trips. This method does not involve a server Central Processing Unit (CPU), and write amplification. This method provides modification of read algorithm to use two atomic operations without limitations in RDMA networks.

Optionally, the handling of the RDMA read request using the counter of the atomic sector includes incrementing the counter. If the write lock bit of the counter is set, the handling of the RDMA read request using the counter of the atomic sector includes sending a Responder Not Ready (RNR), reply to the client. Otherwise, issuing a Direct Memory Access (DMA), read request for a data of the atomic sector and sending a data reply to the client. The handling of the RDMA read request using the counter of the atomic sector includes decrementing the counter.

Optionally, the handling of the RDMA read request using the counter of the atomic sector includes reading the counter. If the write lock bit of the counter is set or the counter value reaches a reading threshold, the handling of the RDMA read request using the counter of the atomic sector includes sending the RNR reply to the client. The handling of the RDMA read request using the counter of the atomic sector includes using an atomic compare and swap operation to update the counter to an incremented value of the counter. If the atomic compare and swap operation fails, returns to the reading of the counter. Otherwise, the handling of the RDMA read request using the counter of the atomic sector includes issuing a DMA read request for a data of the atomic sector, decrementing the counter, and sending a data reply to the client.

Optionally, if the counter value reaches the reading threshold, the method further includes polling the counter one or more times to check whether the counter value decreases below the reading threshold.

Optionally, the handling of the RDMA write request based on the result of the atomic compare and swap operation includes if the atomic compare and swap operation succeeds, issuing a DMA write request, unsetting the write lock bit of the counter, and sending a write reply to the client. Otherwise, the RNIC: if the write lock bit of the counter is clear, the handling of the RDMA write request based on the result of the atomic compare and swap operation includes setting the write lock bit of the counter, polling the counter until all its read counter bits are clear, issuing a DMA write request, unsetting the write lock bit of the counter and sending a write reply to the client. If the write lock bit of the counter is set, the handling of the RDMA write request based on the result of the atomic compare and swap operation includes sending the RNR reply to the client.

Optionally, the defining of the sector atomic memory region includes the RNIC defining the sector atomic memory region in a logical memory range on a host server to that the RNIC provides access.

Optionally, the creating of the array of counters includes the RNIC allocating volatile memory range for the array of counters.

Optionally, the array of counters includes 8-bit counters. Each 8-bit counter has bits 1 to 7 configured as read counter bits.

According to a second aspect, there is provided a Remote Direct Memory Access, (RDMA), Network Interface Controller (RNIC). The RNIC being configured for defining a sector atomic memory region including one or more atomic sectors of a predefined size to which the RNIC provides access only to RDMA requests for atomic sectors that are sector size aligned and span one or more of the sectors. The RNIC being configured for creating an array of counters including a several bit counter for each atomic sector in the sector atomic memory region. Each counter has a bit 0 configured as a write lock bit and one or more further bits configured as read counter bits to be indicative of ongoing operations with the associated atomic sector. In reply to receiving an RDMA read request for an atomic sector from a client, handling the RDMA read request using a counter of the atomic sector. In reply to receiving an RDMA write request for an atomic sector from a client, issuing an atomic compare and swap operation to modify a value of a counter of the atomic sector from 0 to 1 and handling the RDMA write request based on a result of the atomic compare and swap operation.

The RNIC provides an optimal solution for providing direct remote access to the sector atomic memory region without requiring multiple round-trips. The RNIC does not involve a server Central Processing Unit, CPU, and write amplification. The RNIC provides modification of read algorithm to use two atomic operations without limitations in RDMA networks.

Optionally, the RNIC being configured for handing the RDMA read request using the counter of the atomic sector by means of incrementing the counter. If the write lock bit of the counter is set, the RNIC being configured for sending a Responder Not Ready, RNR, reply to the client. Otherwise, the RNIC being configured for issuing a Direct Memory Access. DMA, read request for a data of the atomic sector and sending a data reply to the client. The RNIC being configured for decrementing the counter.

Optionally, the RNIC being configured for handling of the RDMA read request using the counter of the atomic sector by means of reading the counter. If the write lock bit of the counter is set or the counter value reaches a reading threshold, the RNIC being configured for sending the RNR reply to the client. The RNIC being configured for using an atomic compare and swap operation to update the counter to an incremented value of the counter. If the atomic compare and swap operation fails, returns to the reading of the counter. Otherwise, the RNIC being configured for handling of the RDMA read request using the counter of the atomic sector includes issuing a DMA read request for a data of the atomic sector, decrementing the counter, and sending a data reply to the client.

Optionally, if the counter value reaches the reading threshold, the RNIC is further configured for polling the counter one or more times to check whether the counter value decreases below the reading threshold.

Optionally, the RNIC being configured for handling the RDMA write request based on the result of the atomic compare and swap operation by means of: if the atomic compare and swap operation succeeds, issuing a DMA write request, unsetting the write lock bit of the counter, and sending a write reply to the client. Otherwise, if the write lock bit of the counter is clear, the RNIC being configured for the handling the RDMA write request based on the result of the atomic compare and swap operation includes setting the write lock bit of the counter, polling the counter until all its read counter bits are clear, issuing a DMA write request, unsetting the write lock bit of the counter and sending a write reply to the client. If the write lock bit of the counter is set, the RNIC being configured for handling the RDMA write request based on the result of the atomic compare and swap operation includes sending the RNR reply to the client.

Optionally, the RNIC being configured for defining the sector atomic memory region in a logical memory range on a host server to that the RNIC provides access.

Optionally, the RNIC being configured for allocating volatile memory range for the array of counters.

Optionally, the array of counters includes 8-bit counters. Each 8-bit counter has bits 1 to 7 configured as read counter bits.

Therefore, in contradistinction to the prior art, according to a method of controlling Random Direct Memory Access (RDMA) to atomic data sectors, and a Random Direct Memory Access (RDMA) Network Interface Controller (RNIC) provides direct remote access to the sector atomic memory region without requiring multiple round-trips.

These and other aspects of the disclosure will be apparent from the implementation(s) described below.

### BRIEF DESCRIPTION OF DRAWINGS

Implementations of the disclosure will now be described, by way of example only, with reference to the accompanying drawings, in which:

FIG. 1 is a system view of a Remote Direct Memory Access (RDMA), Network Interface Controller (RNIC) in accordance with an implementation of the disclosure;

FIG. 2 is an exemplary system view of a Remote Direct Memory Access. RDMA. Network Interface Controller (RNIC) in accordance with an implementation of the disclosure;

FIG. 3 is an exemplary sequence diagram for providing direct remote access to a memory for one or more clients in accordance with an implementation of the disclosure;

FIGS. 4A and 4B are flow diagrams that illustrate a method of controlling Remote Direct Memory Access (RDMA), to atomic data sectors in accordance with an implementation of the disclosure; and

FIG. 5 is an illustration of a computer system (e.g. a client device or a Remote Direct Memory Access (RDMA), Network Interface Controller (RNIC)) in which the various architectures and functionalities of the various previous implementations may be implemented.

### DETAILED DESCRIPTION OF THE DRAWINGS

Implementations of the disclosure provide a method of controlling Remote Direct Memory Access (RDMA), to atomic data sectors, and a Remote Direct Memory Access. RDMA, Network Interface Controller (RNIC).

To make solutions of the disclosure more comprehensible for a person skilled in the art, the following implementations of the disclosure are described with reference to the accompanying drawings.

Terms such as “a first”, “a second”, “a third”, and “a fourth” (if any) in the summary, claims, and foregoing accompanying drawings of the disclosure are used to distinguish between similar objects and are not necessarily used to describe a specific sequence or order. It should be understood that the terms so used are interchangeable under appropriate circumstances, so that the implementations of the disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units but may include other steps or units that are not expressly listed or that are inherent to such process, method, product, or device.

### Mechanisms Used:

Remote Direct Memory Access (RDMA) protocol uses a Responder Not Ready (RNR), reply to requests sent from clients in cases of high load to throttle access. A client RDMA Network Interface Controller (RNIC) handles the reply by retransmitting the request after a small “cooldown” period.

RNIC memory size has much more on-card memory, and host memory that the RNIC can allocate memory on a host device i.e. a server and access it using Direct Memory Access, (DMA) on a Peripheral Component Interconnect (PCI) bus.

Memory Region (MR) is a logical memory i.e. PM or volatile, range on the host server that the RNIC provides access to. The MR includes characteristics including access permissions i.e. read-only, or read-write, and other protection features.

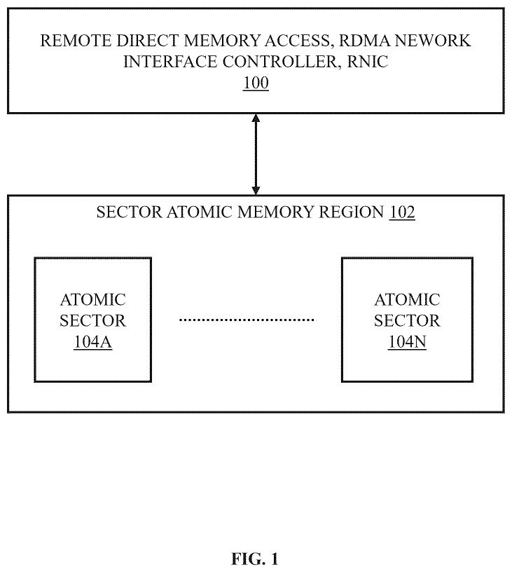

FIG. 1 is a system view of a Remote Direct Memory Access (RDMA), Network Interface Controller (RNIC) 100 in accordance with an implementation of the disclosure. The RNIC 100 is configured for defining a sector atomic memory region 102 including one or more atomic sectors 104A-N of a predefined size to which the RNIC 100 provides access only to RDMA requests for atomic sectors that are sector size aligned and span one or more of the sectors. The RNIC 100 is configured for creating an array of counters including a several bit counter for each atomic sector in the sector atomic memory region 102. Each counter has a bit 0 configured as a write lock bit and one or more further bits configured as read counter bits to be indicative of ongoing operations with the associated atomic sector. In reply to receiving an RDMA read request for an atomic sector from a client, the RNIC 100 is configured for handling the RDMA read request using a counter of the atomic sector. In reply to receiving an RDMA write request for an atomic sector from a client, the RNIC 100 is configured for issuing an atomic compare and swap operation to modify a value of a counter of the atomic sector from 0 to 1 and handling the RDMA write request based on a result of the atomic compare and swap operation.

The RNIC 100 provides an optimal solution for providing direct remote access to the sector atomic memory region 102 without requiring multiple round-trips. The RNIC 100 does not involve a server Central Processing Unit (CPU), and write amplification. The RNIC 100 provides modification of read algorithm to use two atomic operations without limitations in RDMA networks.

The RDMA access to the sector atomic memory region 102 when requests with aligned sector size are provided. Requirements of the requests may be a start on a sector boundary and span one or more full sectors. If the requests are not matched with the requirements, the RNIC 100 is configured to reply with an error to the client. Optionally, the sector size is aligned with storage protocols.

When the sector atomic memory region 102 is configured on the RNIC 100, the RNIC 100 is configured to allocate a volatile memory range to create the array of atomic counters, a counter for each sector in the sector atomic memory region 102 with 8 bits per counter. For example, the sector atomic memory region 102 of 1 GB memory range, 4K sector size, 8 bit per counter requires an array of 1 GB/4K*16=2 MB in a card memory or a host memory.

Optionally, the RNIC 100 being configured for handing the RDMA read request using the counter of the atomic sector by means of incrementing the counter. If the write lock bit of the counter is set, the RNIC 100 being configured for sending a Responder Not Ready, RNR, reply to the client. Otherwise, the RNIC 100 being configured for issuing a Direct Memory Access, DMA, read request for a data of the atomic sector and sending a data reply to the client. The RNIC 100 being configured for decrementing the counter.

Optionally, the RNIC 100 being configured for handling of the RDMA read request using the counter of the atomic sector by means of reading the counter. If the write lock bit of the counter is set or the counter value reaches a reading threshold, the RNIC 100 being configured for sending the RNR reply to the client. The RNIC 100 being configured for using an atomic compare and swap operation to update the counter to an incremented value of the counter. If the atomic compare and swap operation fails, returns to the reading of the counter. Otherwise, the RNIC 100 being configured for handling of the RDMA read request using the counter of the atomic sector includes issuing a DMA read request for a data of the atomic sector, decrementing the counter, and sending a data reply to the client.

Optionally, if the counter value reaches the reading threshold, the RNIC 100 is further configured for polling the counter one or more times to check whether the counter value decreases below the reading threshold.

Optionally, the RNIC 100 being configured for handling the RDMA write request based on the result of the atomic compare and swap operation by means of: if the atomic compare and swap operation succeeds, issuing a DMA write request, unsetting the write lock bit of the counter, and sending a write reply to the client. Otherwise, if the write lock bit of the counter is clear, the RNIC 100 being configured for the handling the RDMA write request based on the result of the atomic compare and swap operation includes setting the write lock bit of the counter, polling the counter until all its read counter bits are clear, issuing a DMA write request, unsetting the write lock bit of the counter and sending a write reply to the client. If the write lock bit of the counter is set, the RNIC 100 being configured for handling the RDMA write request based on the result of the atomic compare and swap operation includes sending the RNR reply to the client.

Optionally, the RNIC 100 being configured for defining the sector atomic memory region 102 in a logical memory range on a host server to that the RNIC 100 provides access.

Optionally, the RNIC 100 being configured for allocating volatile memory range for the array of counters.

Optionally, the array of counters includes 8-bit counters. Each 8-bit counter has bits 1 to 7 configured as read counter bits. Optionally, a structure of the counter includes Bit 0—write lock bit which progresses a write operation, and Bits 1-7—read counter bits which progresses read operations.

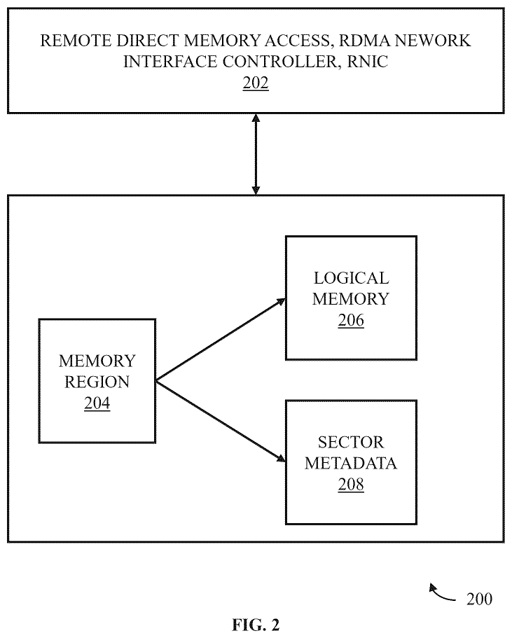

FIG. 2 is an exemplary system view 200 of a Remote Direct Memory Access. (RDMA), Network Interface Controller (RNIC) 202 in accordance with an implementation of the disclosure. The system view 200 includes the RNIC 202, a memory region 204, a logical memory 206, and a sector metadata 208. The RNIC 202 is configured to receive a Remote Direct Memory Access (RDMA), read request for the sector metadata 208, which automatically increments a matching counter in the sector metadata 208. The RDMA read request may be received on the memory region 204, which enables communicating with the sector metadata 208 for incrementing the counter. Optionally, an algorithm for the increment in the matching counter is with (atomic_fetch_inc). If the counter value including a bit 0 is set as ‘write lock bit’, the RNIC 202 progresses a write operation. If the bit 0 is clear, issue DMA read for data and send data reply back. When the DMA read is done, decrement the atomic counter back to signal the read is done. Optionally, an algorithm for the decrement in the matching counter is with (atomic_fetch_dec). The RNIC 202 is configured to send a Responder Not Ready, RNR reply to a client. The logical memory 206 may enable access to the RNIC 202 for read and write operations.

Read algorithm for the RNIC 202 to read the sector metadata 208 as follows,

```
read request arrives for sector X
val = atomic_fetch_inc(X)
If (val.0==1) then
  atomic_dec(X)
  reply RNR
else (val.0!=1) then
  DMA read X
  atomic_dec(X)
  send read reply
```

The RNIC 202 is configured to receive a RDMA write request for the sector metadata 208, the RNIC 202 issue an atomic compare and swap operation to the matching counter for modifying a value from 0 to 1. Optionally, the atomic compare and swap operation is with (atomic_cas). Value 0 may include no reads and writers, and value 1 may include write lock. If the atomic compare and swap operation succeed, the sector metadata 208 is locked and the atomic compare and swap operation continues and enables the RNIC 202 to issue Direct Memory Access, DMA write, unset bit 0 after completion of the atomic compare and swap operation, and send a reply to the client. If the atomic compare and swap operation fails, the RNIC 202 is configured to automatically set bit 0 to indicate that the write request is pending and poll the counter until all reads are complete i.e. clearing read counter bits. The write request that is pending may prevent read operations, and enables the RNIC 202 to proceed with the write operation after clearing the read counter bits. If bit 0 is already set by the RNIC 202 with the write operation that is pending, the RNIC 202 is configured to reply with RNR to the client.

Write algorithm for the RNIC 202 to write on the sector metadata 208 as follows,

```
write request arrives for sector X
val = atomic_cas(X, 0, 1)
If (val==success) then
  DMA write X
atomic_cas(X, 1, 0)
  reply write
else (val==fail) then
  val=atomic_fetch_set(X, 1)
  if (val==0) then
    while atomic_read(X)>1 repeat
    DMA write X
    atomic_cas(X, 1, 0)
    reply write
  else (val==1) then
    reply RNR
```

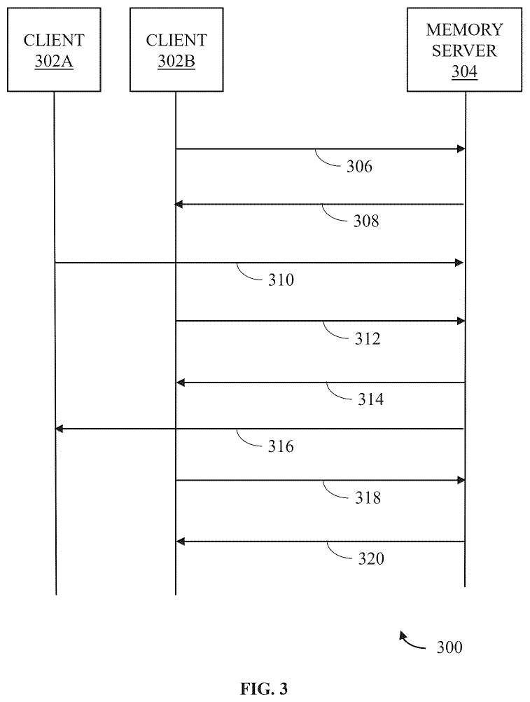

FIG. 3 is an exemplary sequence diagram 300 for providing direct remote access to a memory for one or more clients 302A-B in accordance with an implementation of the disclosure. The sequence diagram 300 includes the one or more clients 302A-B and a memory server 304 that is associated with the memory. The one or more clients include a first client 302A, and a second client 302B. The memory server 304 associated with the memory may be a logical memory or a volatile memory. The sequence diagram 300 provides the direct remote access to the memory server 304 as a storage media with sector atomicity. Read algorithm may be modified to use two atomic operations to modify the counter. The two atomic operations may be to read the counter and check for overflow, and use an atomic compare and swap operation to update the counter. Optionally, the atomic compare and swap operation is an atomic compare and exchange operation.

At a step 306, the second client 302B sends a first RDMA read sector X to the memory server 304. At a step 308, the memory server 304 sends an acknowledgement with old data with respect to the first RDMA read sector X. At a step 310, the first client 302A sends a RDMA write sector X to the memory server 304. At a step 312, the second client 302B sends a RDMA read sector X to the memory server 304. At a step 314, the memory server 304 sends a Responder Not Ready, RNR to the second client 302B as the write request from the first client 302A is pending. At a step 316, the memory server 304 sends a write acknowledgement with respect to the RDMA write sector X to the first client 302A. At a step 318, the second client 302B sends a RDMA read offset X to the memory server 304. At a step 320, the memory server 304 sends an acknowledgment with new data with respect to the RDMA read offset X.

The Read algorithm may be as follows,

```
read request arrives for sector X
val = atomic_read(X) // STEP 2
If(val.0==1) then
  reply RNR
If(val.counter>=MAX_READ)
  reply RNR
new_val = val.counter++
val=atomic_cas(vas, new_val)
If(val != new_val)
  goto step 2
else
  DMA read X
  atomic_dec(X)
  send read reply
```

Optionally, optimization of the direct remote access poll the atomic counter one or more times if the counter is released, without sending RNR.

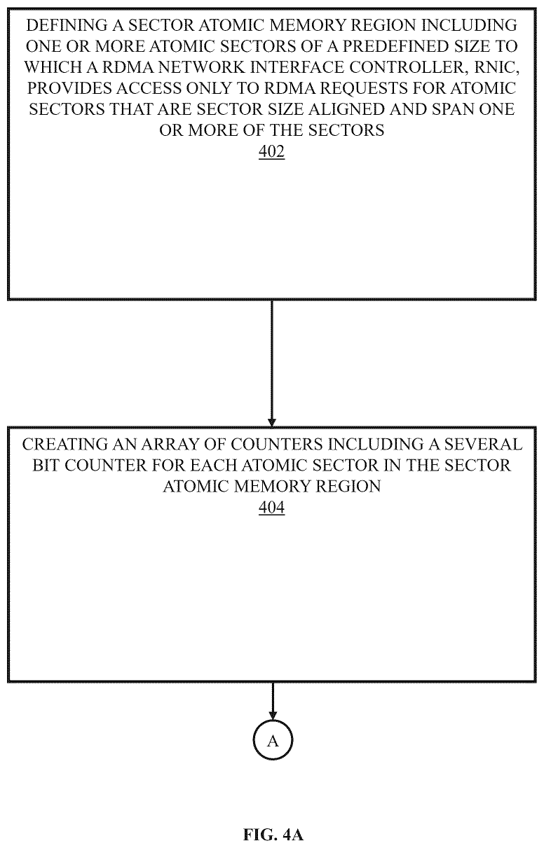

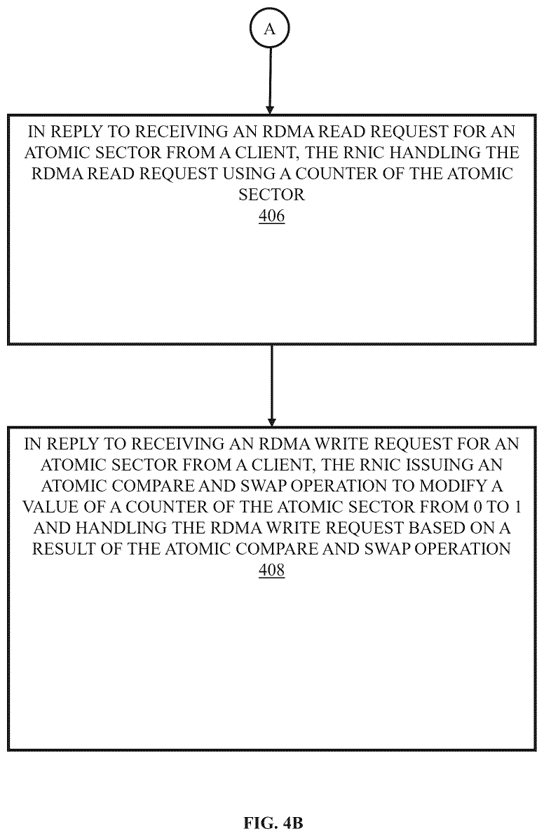

FIGS. 4A and 4B are flow diagrams that illustrate a method of controlling Remote Direct Memory Access (RDMA), to atomic data sectors in accordance with an implementation of the disclosure. At a step 402, a sector atomic memory region including one or more atomic sectors of a predefined size is defined to which a RDMA Network Interface Controller (RNIC), provides access only to RDMA requests for atomic sectors that are sector size aligned and span one or more of the sectors. At a step 404, an array of counters including a several bit counter for each atomic sector is created in the sector atomic memory region. Each counter has a bit 0 configured as a write lock bit and one or more further bits configured as read counter bits to be indicative of ongoing operations with the associated atomic sector. At a step 406, in reply to receiving an RDMA read request for an atomic sector from a client, the RNIC handling the RDMA read request using a counter of the atomic sector. At a step 408, in reply to receiving an RDMA write request for an atomic sector from a client, the RNIC issuing an atomic compare and swap operation to modify a value of a counter of the atomic sector from 0 to 1 and handling the RDMA write request based on a result of the atomic compare and swap operation.

This method provides an optimal solution for providing direct remote access to the sector atomic memory region without requiring multiple round trips. This method does not involve a server Central Processing Unit (CPU), and write amplification. This method provides modification of read algorithm to use two atomic operations without limitations in RDMA networks.

Optionally, the handling of the RDMA read request using the counter of the atomic sector includes incrementing the counter. If the write lock bit of the counter is set, the handling of the RDMA read request using the counter of the atomic sector includes sending a Responder Not Ready (RNR), reply to the client. Otherwise, issuing a Direct Memory Access (DMA), read request for a data of the atomic sector and sending a data reply to the client. The handling of the RDMA read request using the counter of the atomic sector includes decrementing the counter.

Optionally, the handling of the RDMA read request using the counter of the atomic sector includes reading the counter. If the write lock bit of the counter is set or the counter value reaches a reading threshold, the handling of the RDMA read request using the counter of the atomic sector includes sending the RNR reply to the client. The handling of the RDMA read request using the counter of the atomic sector includes using an atomic compare and swap operation to update the counter to an incremented value of the counter. If the atomic compare and swap operation fails, returns to the reading of the counter. Otherwise, the handling of the RDMA read request using the counter of the atomic sector includes issuing a DMA read request for a data of the atomic sector, decrementing the counter, and sending a data reply to the client.

Optionally, if the counter value reaches the reading threshold, the method further includes polling the counter one or more times to check whether the counter value decreases below the reading threshold.

Optionally, the handling of the RDMA write request based on the result of the atomic compare and swap operation includes if the atomic compare and swap operation succeeds, issuing a DMA write request, unsetting the write lock bit of the counter, and sending a write reply to the client. Otherwise, the RNIC: if the write lock bit of the counter is clear, the handling of the RDMA write request based on the result of the atomic compare and swap operation includes setting the write lock bit of the counter, polling the counter until all its read counter bits are clear, issuing a DMA write request, unsetting the write lock bit of the counter and sending a write reply to the client. If the write lock bit of the counter is set, the handling of the RDMA write request based on the result of the atomic compare and swap operation includes sending the RNR reply to the client.

Optionally, the defining of the sector atomic memory region includes the RNIC defining the sector atomic memory region in a logical memory range on a host server to that the RNIC provides access.

Optionally, the creating of the array of counters includes the RNIC allocating volatile memory range for the array of counters.

Optionally, the array of counters includes 8-bit counters. Each 8-bit counter has bits 1 to 7 configured as read counter bits.

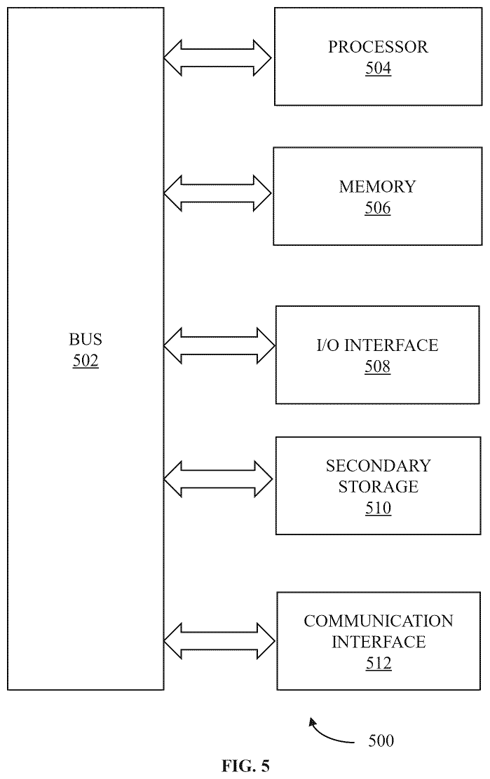

FIG. 5 is an illustration of a computer system (e.g. a client device or a Remote Direct Memory Access (RDMA), Network Interface Controller (RNIC)) in which the various architectures and functionalities of the various previous implementations may be implemented. As shown, the computer system 500 includes at least one processor 504 that is connected to a bus 502, wherein the computer system 500 may be implemented using any suitable protocol, such as PCI (Peripheral Component Interconnect), PCI-Express, AGP (Accelerated Graphics Port), Hyper Transport, or any other bus or point-to-point communication protocol (s). The computer system 500 also includes a memory 506.

Control logic (software) and data are stored in the memory 506 which may take a form of random-access memory (RAM). In the disclosure, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The computer system 500 may also include a secondary storage 510. The secondary storage 510 includes, for example, a hard disk drive and a removable storage drive, representing a floppy disk drive, a magnetic tape drive, a compact disk drive, digital versatile disk (DVD) drive, recording device, universal serial bus (USB) flash memory. The removable storage drive at least one of reads from and writes to a removable storage unit in a well-known manner.

Computer programs, or computer control logic algorithms, may be stored in at least one of the memory 506 and the secondary storage 510. Such computer programs, when executed, enable the computer system 500 to perform various functions as described in the foregoing. The memory 506, the secondary storage 510, and any other storage are possible examples of computer-readable media.

In an implementation, the architectures and functionalities depicted in the various previous figures may be implemented in the context of the processor 504, a graphics processor coupled to a communication interface 512, an integrated circuit (not shown) that is capable of at least a portion of the capabilities of both the processor 504 and a graphics processor, a chipset (namely, a group of integrated circuits designed to work and sold as a unit for performing related functions, and so forth).

Furthermore, the architectures and functionalities depicted in the various previous-described figures may be implemented in a context of a general computer system, a circuit board system, a game console system dedicated for entertainment purposes, an application-specific system. For example, the computer system 500 may take the form of a desktop computer, a laptop computer, a server, a workstation, a game console, an embedded system.

Furthermore, the computer system 500 may take the form of various other devices including, but not limited to a personal digital assistant (PDA) device, a mobile phone device, a smart phone, a television, and so forth. Additionally, although not shown, the computer system 500 may be coupled to a network (for example, a telecommunications network, a local area network (LAN), a wireless network, a wide area network (WAN) such as the Internet, a peer-to-peer network, a cable network, or the like) for communication purposes through an I/O interface 508.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

What is claimed is:

1. A method of controlling Remote Direct Memory Access, RDMA, to atomic data sectors, comprising:
defining a sector atomic memory region (102) comprising a plurality of atomic sectors (104A-N) of a predefined size to which an RDMA network interface controller, RNIC (100, 202), provides access only to RDMA requests for atomic sectors that are sector size aligned and span one or more of the sectors,
creating an array of counters comprising a several bit counter for each atomic sector in the sector atomic memory region (102), wherein each counter has a bit 0 configured as a write lock bit and one or more further bits configured as read counter bits to be indicative of ongoing operations with the associated atomic sector,
in reply to receiving an RDMA read request for an atomic sector from a client, the RNIC (100, 202) handling the RDMA read request using a counter of said atomic sector, and
in reply to receiving an RDMA write request for an atomic sector from a client, the RNIC (100, 202) issuing an atomic compare and swap operation to modify a value of a counter of said atomic sector from 0 to 1 and handling the RDMA write request based on a result of the atomic compare and swap operation.

2. The method of claim 1, wherein the handling of the RDMA read request using the counter of said atomic sector comprises:
incrementing the counter,
if the write lock bit of the counter is set, sending a Responder Not Ready, RNR, reply to the client,
otherwise, issuing a Direct Memory Access, DMA, read request for a data of the atomic sector and sending a data reply to the client, and
decrementing the counter.

3. The method of claim 1, wherein the handling of the RDMA read request using the counter of said atomic sector comprises:
reading the counter,
if the write lock bit of the counter is set or the counter value reaches a reading threshold, sending the RNR reply to the client,
using an atomic compare and swap operation to update the counter to an incremented value of the counter,
if the atomic compare and swap operation fails, returns to the reading of the counter,
otherwise, issuing a DMA read request for a data of the atomic sector, decrementing the counter, and sending a data reply to the client.

4. The method of claim 3, wherein if the counter value reaches the reading threshold, the method further comprising polling the counter one or more times to check whether the counter value decreases below the reading threshold.

5. The method of claim 1, wherein the handling of the RDMA write request based on the result of the atomic compare and swap operation comprises:
if the atomic compare and swap operation succeeds, issuing a DMA write request, unsetting the write lock bit of the counter, and sending a write reply to the client,
otherwise, the RNIC (100, 202):
if the write lock bit of the counter is clear, setting the write lock bit of the counter, polling the counter until all its read counter bits are clear, issuing a DMA write request, unsetting the write lock bit of the counter and sending a write reply to the client, and
if the write lock bit of the counter is set, sending the RNR reply to the client.

6. The method of claim 1, wherein the defining of the sector atomic memory region (102) comprises the RNIC (100, 202) defining the sector atomic memory region (102) in a logical memory range on a host server to that the RNIC (100, 202) provides access.

7. The method of claim 1, wherein the creating of the array of counters comprises the RNIC (100, 202) allocating volatile memory range for the array of counters.

8. The method of claim 1, wherein the array of counters comprises 8-bit counters, wherein each 8-bit counter has bits 1 to 7 configured as read counter bits.

9. A Remote Direct Memory Access, RDMA, network interface controller, RNIC (100, 202), being configured for:
defining a sector atomic memory region (102) comprising a plurality of atomic sectors of a predefined size to which the RNIC (100, 202) provides access only to RDMA requests for atomic sectors that are sector size aligned and span one or more of the sectors,
creating an array of counters comprising a several bit counter for each atomic sector in the sector atomic memory region (102), wherein each counter has a bit 0 configured as a write lock bit and one or more further bits configured as read counter bits to be indicative of ongoing operations with the associated atomic sector,
in reply to receiving an RDMA read request for an atomic sector from a client, handling the RDMA read request using a counter of said atomic sector, and
in reply to receiving an RDMA write request for an atomic sector from a client, issuing an atomic compare and swap operation to modify a value of a counter of said atomic sector from 0 to 1 and handling the RDMA write request based on a result of the atomic compare and swap operation.

10. The RNIC (100, 202) of claim 9, being configured for handling the RDMA read request using the counter of said atomic sector by means of:
incrementing the counter,
if the write lock bit of the counter is set, sending a Responder Not Ready, RNR, reply to the client,
otherwise, issuing a Direct Memory Access, DMA, read request for a data of the atomic sector and sending a data reply to the client, and
decrementing the counter.

11. The RNIC (100, 202) of claim 9, being configured for handling the RDMA read request using the counter of said atomic sector by means of:
reading the counter,
if the write lock bit of the counter is set or the counter value reaches a reading threshold, sending the RNR reply to the client,
using an atomic compare and swap operation to update the counter to an incremented value of the counter,
if the atomic compare and swap operation fails, returns to the reading of the counter,
otherwise, issuing a DMA read request for a data of the atomic sector, decrementing the counter, and sending a data reply to the client.

12. The RNIC (100, 202) of claim 11, wherein if the counter value reaches the reading threshold, the RNIC (100, 202) is further configured for polling the counter one or more times to check whether the counter value decreases below the reading threshold.

13. The RNIC (100, 202) of claim 9, being configured for handling the RDMA write request based on the result of the atomic compare and swap operation by means of:
if the atomic compare and swap operation succeeds, issuing a DMA write request, unsetting the write lock bit of the counter, and sending a write reply to the client,
otherwise:
if the write lock bit of the counter is clear, setting the write lock bit of the counter, polling the counter until all its read counter bits are clear, issuing a DMA write request, unsetting the write lock bit of the counter and sending a write reply to the client, and
if the write lock bit of the counter is set, sending the RNR reply to the client.

14. The RNIC (100, 202) of claim 9, being configured for defining the sector atomic memory region (102) in a logical memory range on a host server to that the RNIC (100, 202) provides access.

15. The RNIC (100, 202) of claim 9, being configured for allocating volatile memory range for the array of counters.

16. The RNIC (100, 202) of claim 9, wherein the array of counters comprises 8-bit counters, wherein each 8-bit counter has bits 1 to 7 configured as read counter bits.
